(19) United States
(12) Patent Application Publication
(10) Pub. No.: US 2009/0182664 A1
(43) Pub. Date: Jul. 16, 2009

(54) INTEGRATING SOCIAL NETWORKING WITH FINANCIAL SERVICES

(76) Inventor: Austin D. Trombley, Kansas City, MO (US)

Correspondence Address: FISH & RICHARDSON PC, P.O. BOX 1022, MINNEAPOLIS, MN, 55440-1022, US

(21) Appl. No.: 12/014,206

(22) Filed: Jan. 15, 2008

(51) Int. Cl. G06Q 30/00; G06Q 40/00

(52) U.S. Cl. 705/42

(57) ABSTRACT

A method for integrating an online social networking platform with a banking platform enables users of the online social networking platform to transfer funds held in one or more accounts accessed through the banking platform to a third party.

### BACKGROUND OF THE INVENTION

This invention relates to integrating social networking with financial services.

An online social networking system is described in Lunt et al., U.S. Pat. No. 7,188,153 in which people interact with each other over a computer network.

### BRIEF SUMMARY OF THE INVENTION

In general, in one aspect, the invention features a method that includes integrating an online social networking platform with a banking platform to enable users of the online social networking platform to transfer funds held in one or more accounts (e.g., a checking account, a savings account, a brokerage account, and a credit card account) accessed through the banking platform to a third party.

In general, in another aspect, the invention features a method that includes providing a user of an online social networking platform with access to a first account associated with a monetary instrument, the first account belonging to the user; and enabling the user to transfer a selected amount of funds from the first account to a second account belonging to a third party.

In general, in a further aspect, the invention features a method that includes retrieving account information from a banking platform, the account information associated with an account belonging to a user; providing the account information to an online social networking platform configured to display the account information to the user; receiving a user command to transfer funds from the account to a designated recipient; and transferring the funds from the account belonging to the user to an account belonging to the designated recipient.

In general, in yet a further aspect, the invention features a method performed at an online social networking platform, the method including enabling a user to transfer funds from a first account belonging to the user to a second account belonging to a third party; and deriving revenue from a transfer of the funds and distributing at least portions of the revenue to a party that operates the social networking platform.

In general, in yet a further aspect, the invention features a method that includes compensating a provider of a third party platform for providing financial services to a user through a social networking platform, where the third party platform is in electronic communication with the social networking platform and a banking platform, and where the banking platform provides access to one or more accounts belonging to the user. Examples of financial services include: transferring funds from the one or more accounts to a third party; and depositing funds received from another user of the social networking platform to the one or more accounts.

In general, in yet a further aspect, the invention features a system that includes a social networking platform configured to provide social networking services and financial services to a plurality of users interacting with the social networking platform using client computers communicatively coupled to the social networking platform.

Implementations may include one or more of the following. The third party may include one or more other users of the social networking platform, a company, corporation, or organization. Authentication information (e.g., a login and password) may be requested from the user; and verified before the user is provided access to an account. Further authentication information (e.g., a personal identification number) may be requested from the user just before initiating a transfer of the funds. The authentication information may be provided to the banking platform to verify the identity of the user. The designated recipient may be another user of the online social networking platform that has previously established a relationship through the social networking platform. Confirmation of a processed transaction, which displays the amount of transferred funds and the recipient of the funds, may be provided to the user from the social networking platform. Information corresponding to the one or more accounts may be stored at a third party platform that handles transactions with the banking platform.

Deriving revenue may include collecting a percentage of the amount of funds transferred and/or collecting a fixed fee in exchange for initiating the transfer of funds. The derivation and distribution of revenue may be adjusted according to the amount of the funds transferred. Fees may also be charged to the user for depositing funds to and withdrawing funds from the one or more accounts. Funds collected from the one or more accounts may be held in a purse account maintained by the third party platform that uses the funds to provide the financial services and collects interest on the funds

The system may further include a banking platform coupled to the social networking platform, where the banking platform includes an accounts database storing account information of accounts belonging to one or more of the plurality of users. The system may further include a clearing house platform coupled to the social networking platform and the banking platform, where the clearing house platform is configured to realize financial transactions initiated between the social networking platform and the banking platform.

Advantages may include one or more of the following. An online social networking platform is integrated with a banking platform to provide financial services to users through the social networking platform. Users of the social networking platform can transfer funds to third parties which include other members of the social networking platform and nonmember third parties such as companies, organizations, and individuals. Users can check bank balances, transactions, and other account activity at any time when they are logged into the social networking service. Users can easily confirm transactions with other users of the social networking service using standard tools provided by the service for communication, e.g., messaging, chat, and email. The system keeps a record of transactions for use in establishing a money trail.

The details of one or more embodiments are set forth in the accompanying drawings and the description below. Other features, objects, and advantages will be apparent from the description and drawings, and from the claims.

### BRIEF DESCRIPTION OF THE SEVERAL VIEWS OF THE DRAWING

FIG. 1 is a block diagram of an integrated social networking and financial services system,

FIGS. 2A-B is a flowchart of a process for providing financial services to a social networking site, and

FIGS. 3-12 are screenshots of a user console for integrating social networking services and financial services.

### DETAILED DESCRIPTION

Online social networking is a service that enables people to interact with each other over a computer network, e.g., the Internet, and create online communities whose members often share common interests, hobbies, backgrounds, etc. Social networking services may be web-based and provide various ways for users to interact, such as chat, messaging, email, video, voice chat, file sharing, blogging, discussion groups, and so on. Social networking services may contain directories of categories (e.g., former classmates) and tools to enable users to connect with friends and colleagues. Currently, some of the most popular social networking services include MySpace and Facebook.

A business model of social networking generates revenue from selling online advertising on their sites. For example, Facebook makes money on pageviews and click fees for people that click on advertisements posted on the Facebook website. Social networking services are also seeking other ways to generate revenue, such as by selling items directly to users (e.g., Facebook enables users to purchase “gifts” in the form of icons and send them to other users) or by selling user information to third parties

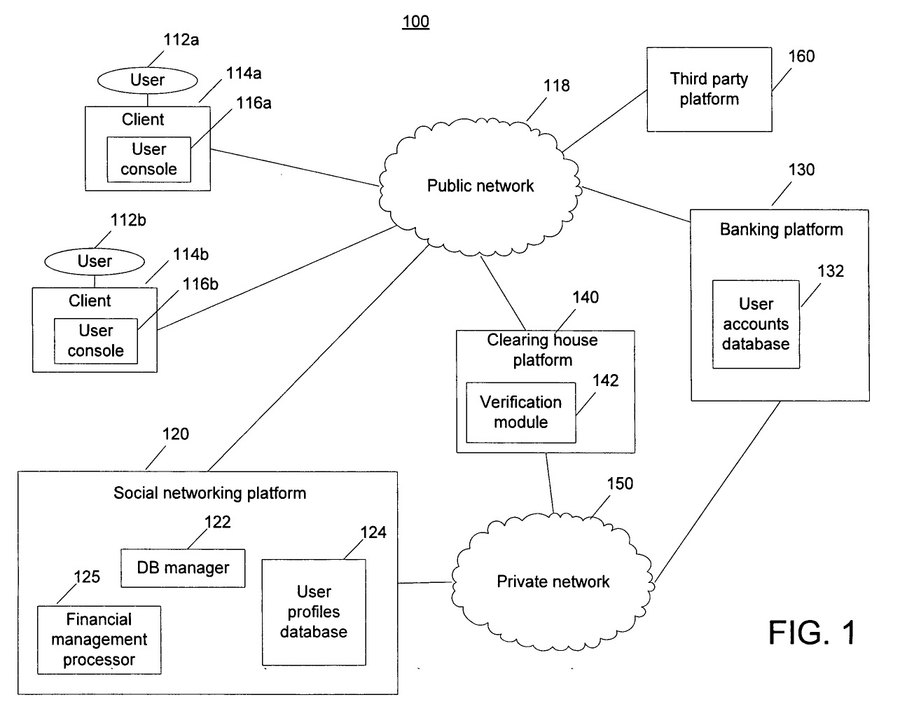

As shown in broad terms in FIG. 1, a system 100 integrates an online social networking platform 120 and a banking platform 130 to deliver financial services to users 112a and 112b (collectively referred to as “users 12”) through the social networking platform 120. Examples of financial services include but are not limited to accessing monetary accounts (e.g., a checking account); transferring funds from an account to another entity (e.g., other users, companies, organizations, and individuals); receiving funds from other parties (e.g., other users); and initiating financial transactions. The term “service” includes all of the features, systems, and methods described here for delivering financial services through the social networking platform 120.

In addition to the social networking platform 120 and the banking platform 130, the system 100 includes a clearing house platform 140, which provides clearing and settlement services for financial transactions initiated between the social networking platform 120 and the banking platform 130; and one or more third party platforms (referred to as “third party platform 150”). The system 100 also includes client computers 114a and 114b, which are controlled, respectively, by users 112a and 112b; a public network 118 (e.g., the Internet) that delivers data between the client computers 114a and 114b (collectively referred to as “client computers 114”) and the social networking platform 120; and an optional private network 150 that delivers data between the social networking platform, the clearing house platform 140, and the banking platform 130. Although the social networking platform 120, the clearing house platform 140, and the banking platform 130 are shown connected to the public network 118, in some embodiments, they communicate solely over the private network 150. In other embodiments they communicate solely over the public network 118, in which case the private network 150 is omitted from the system 100. In further embodiments, they communicate using both the public network 118 and the private network 150. Although the social networking platform 120 and the clearing house platform 140 are shown as two separate and distinct entities in FIG. 1, in some embodiments, the social networking platform 120 and the clearing house platform 140 are integrated into a single platform. The social networking platform 120 may also communicate directly with the banking platform 130 without any coordination with the clearing house platform 140.

The social networking platform 120 includes a database 124 that stores user profiles that the users 112 of the social networking platform 120 create for themselves. For example, users 112 can upload a picture of themselves and can establish relationships or links to other users, e.g., users can be “friends” with other users. In some embodiments, both users, i.e., the user making contact and the user being contacted, must confirm the relationship, e.g., that they are friends, before the relationship is established and recognized by the social networking platform 120. For example, if the first user 112a lists the second user 112b as a friend, then the first user 112a would have to approve the second user's 112b friend request before they are listed as friends.

The social networking platform 120 includes privacy controls that allows users 112 to choose who can view their profile or contact them, among other functions. The social networking platform 120 may provide users additional functionality, such as the ability to create groups that share common interests or affiliations, upload videos, and hold discussions in forums. The social networking platform 120 also includes a database manager 122 for managing the contents of the user profiles database 124, applying privacy controls, and performing other functions that make use of the contents in the database 124.

The banking platform 130 may be any platform associated with a financial institution and may represent multiple platforms associated with different financial institutions, e.g., banks, building societies, credit unions, stock brokerages, asset management firms, and similar businesses. The banking platform 130 may also include online payment processing businesses such as PayPal™. The banking platform 130 includes a database 132 of one or more accounts belonging to the users 112.

The client computers 114a-b (collectively referred to as “client computers 114”) include user consoles 116a-b (collectively referred to as “user consoles 116”), which are user interfaces through which the users 112 interact with the social networking platform 112. Via the user console 116a, a user 112a registers with the social networking platform 112, which in turn creates an account or profile for the user 112a and stores the profile in the profile database 124. The user profile includes identification information and contact information associated with the user 112a and personal information supplied by the user 12a, e.g., interests and hobbies, professional experience.

The user profile also includes a list of the user's accounts and/or institutions in which the user owns one or more accounts. In some embodiments, the user profile also includes authentication information, e.g., a login and password, associated with the account. In the user console 116a, the user 112a can request to access a particular account, e.g., by entering information that identifies the account, e.g., such as an account name or number and/or information that identifies an institution with which the desired account is associated. The user 112a may also submit other financial services requests, for example, a request to transfer a predetermined amount of funds from a selected account to a particular recipient, e.g., another user 112b, company, organization, or other third party. Such a fund transfer request includes information identifying an account, an amount of funds to be transferred, and information identifying the recipient.

The clearing house platform 140 provides users 112 with access to one or more accounts maintained at the banking platform 130 and implements transactions, e.g., electronic transfers of funds, as well as other financial services requested by a user through the social networking platform 120. As will be described in further detail below, after a user 112a enters a request for financial services through the user console 116a, e.g., account access or fund transfer, the social networking platform 120 sends the request to the clearing house platform 140. The clearing house platform 140 obtains authentication information, such as a login and password, associated with the account or institution identified in the request. In some embodiments, the clearing house platform 140 sends a request to the social networking platform 120 to solicit the authentication information from the user 112a. In other embodiments, the social networking platform 120 may automatically send the authentication information to the clearing house platform 140 with the initial request. The clearing house platform 140 includes a verification module 142 that verifies the authentication information supplied by the user to ensure that user 112a is indeed the rightful owner of the requested account.

After verifying the authentication information, the clearing house platform 140 contacts the appropriate banking platform 130 and requests access to the user's account. The clearing house platform 140 communicates with the banking platform 130 to distribute an electronic debit entry to the user's account and a credit entry to a recipient account, which may be maintained on the same or at a different banking platform 130 or on the third party platform 160. For example, the recipient account maintained on the third party platform 160 may be an online bill pay account (e.g., for utility services, telephone services, and cable services.) that belongs to the user 112a requesting the fund transfer or to a different user 112b. As described above, the clearing house platform 140 may be integrated with the social networking platform 120 to provide a single platform. Alternatively, the clearing house platform 140 may be integrated with one or more of the banking platform 130 and the third party platform 160.

The third party platform 160 may represent any company, organization, e-commerce business or individual with which a user 112a has a financial agreement or would like to enter a financial agreement. For example, the third party platform could be a company that provides a fee-based service to the user 112a, e.g., a utility company. The third party platform could be a company that sells a product that the user 112a wishes to purchase online (e.g., a book from Amazon.com). The third party platform could be an e-commerce business, such as Paypal™, or an online auction business, such as eBay™.

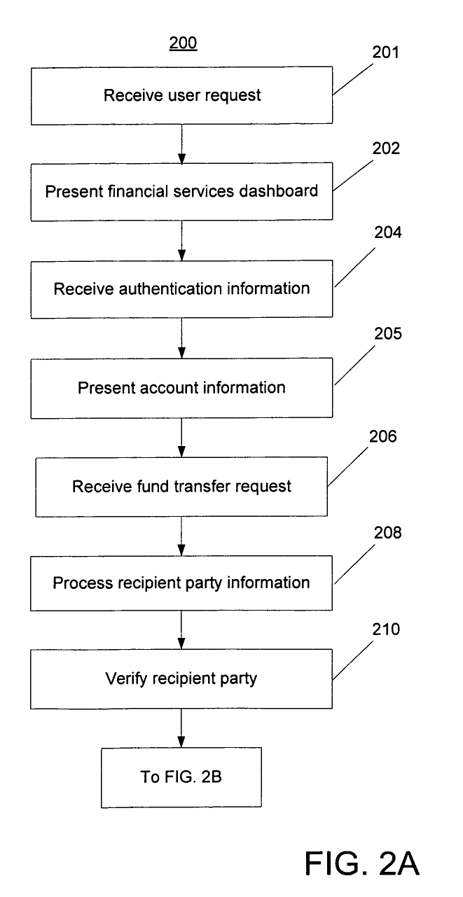

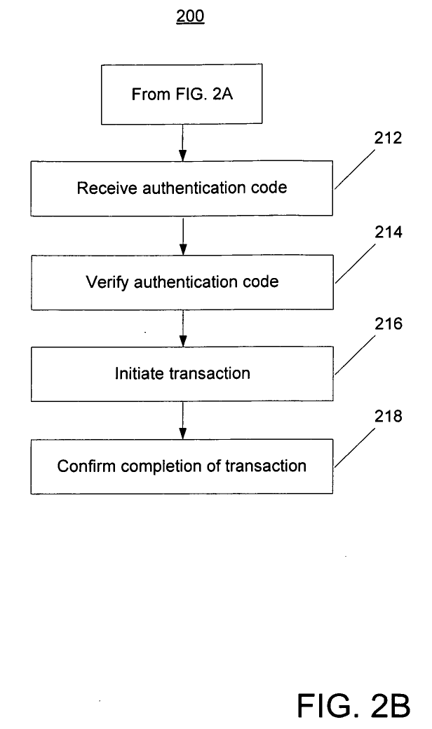

Referring to FIGS. 2A-B, the social networking platform 120, operating in conjunction with the clearing house platform 140, performs a process 200 for providing financial services to users 112 interacting with the social networking platform 120. In the user console 116a, the process 200 receives (201) a request from a user 112a to access an account and/or financial institution that maintains accounts on the banking platform 130. The request may be in the form of text entered by a user or a user selection of a financial services icon or option from a menu presented from the social networking platform 120 through the user console 116a.

The process 200 then presents (202) a financial service console or “banking dashboard” on the user console 116a. The dashboard includes a login prompt or other similar prompt for authentication information to a user 112a. The user then enters the requested authentication information into the prompt. For example, the user may enter a login and password associated with the account he or she wants to access. The process 200 then receives (204) the authentication information and sends it to either the clearing house platform 140 or directly to the banking platform 130 for verification. In some embodiments, the process 200 requires the user to enter the authentication information into the prompt only during the first time the user attempts to access an account. In these embodiments, the social networking platform 120 stores the authentication information and automatically enters it into the prompt for each subsequent request received from the user 112a. Automatically entering the authentication information into the prompt for subsequent accesses can save the user 112a time and expedite the delivery of the requested financial services.

The social networking platform 120 communicates with the banking platform 130, either directly or through the clearing house platform 140, to obtain information associated with the requested account. This information includes, but is not limited to, an account balance, recent transactions involving the account, and pending transactions. In some embodiments, the banking platform 130 enables the social networking platform 120 to form a communication channel through which the social networking platform 120 can directly access the account information from the accounts database 132.

Through the banking dashboard, the process 200 presents (205) the account information obtained from the banking platform 130. The banking dashboard provides controls that enable users 112 to select various types of account information for display. For example, the dashboard provides a list of accounts associated with the user 112a at a particular financial institution, account balances, transactions, and other information. In some embodiments, the dashboard includes a portal to the banking platform 130 to enable the user 112a to interact directly with the website maintained by the banking platform 130.

Through the banking dashboard, users 112 submit a request to transfer funds to a third party, which may be another user of the social networking platform, e.g., a “friend” of the user 112a, another individual, company, organization, and the like. The transfer request identifies the account, the amount of funds to be debited from the account, and a recipient party. The process 200 receives (206) the transfer request and processes (208) the recipient party information to determine an account in which to transfer the funds. For example, if the recipient party is a another user 112b of the social networking platform 120, the process determines an account of the user 112b, referred to as a “recipient account,” in which to transfer the funds. The process determines the recipient account from the information stored in the user profile for the user 112b. If the third party is not another user of the social networking platform 120, but rather another company or organization, the process 120 may open a communication connection between an associated third party platform 160 to enable to the user 112a to access his or her account maintained at the third party platform 160.

Before a transaction is processed, the process 200 requests the user 112a to verify (210) the recipient party. For example, the process 200 may require the user 112a to actuate an icon (e.g., click a button) presented in the user console 116a to confirm that the designated recipient party is correct. The process 200 also requests the user to enter additional authentication information, e.g., in the form of a personal identification code that is different from the authentication information received in step 204. The process 200 receives (212) the authentication code and verifies (214) with the either the banking platform 1130 or the clearing house platform 140.

The process 200 may optionally verify whether the amount selected for transfer is below a predetermined cap on the maximum amount that can be transferred. The cap may be set by the social networking platform 120 or by the user 112a. In some embodiments, the cap is set by the system 120 at a default amount that can be later adjusted by the user 112a. If the amount exceeds the cap, the process 200 sends the user 112a an error message with a prompt to reduce the amount.

After the verification processes have been completed, the process 200 initiates (216) the requested transaction via the clearing house platform 140, as described above. Alternatively, the process 200 may initiate the transaction directly with the banking platform 130. Upon completion of the transaction, the process 200 sends confirmation to the user 112a through the user console 116. The confirmation, for example, may be in the form of a message displayed on the user console 116 and/or an email delivered to the user 112a. The process 200 records the transaction in a record of transactions initiated by the user 112a. Such a record can be used to establish a money trail.

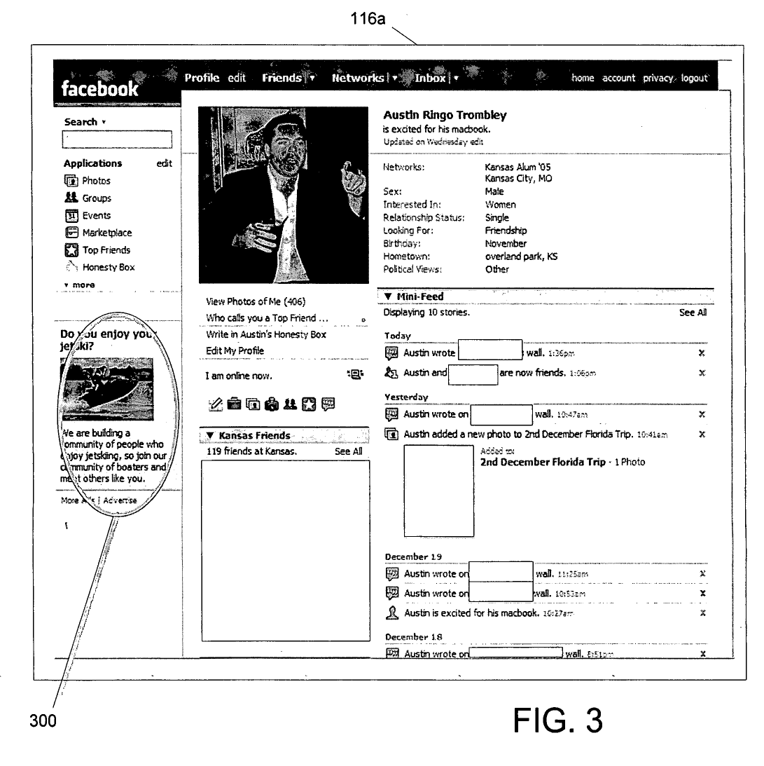

FIGS. 3-12 show screenshots of exemplary tools provided by the user consoles 116 for enabling users 112 to obtain financial services through the social networking platform 120.

FIG. 3 shows an example of an initial user homepage maintained on the social networking platform 120 and presented through the user console 116a. The circled material 300 includes an advertisement and is representative of a current site business model, where the social networking platform 120 derives revenue from pageviews and fees when users 112 click on the advertisement.

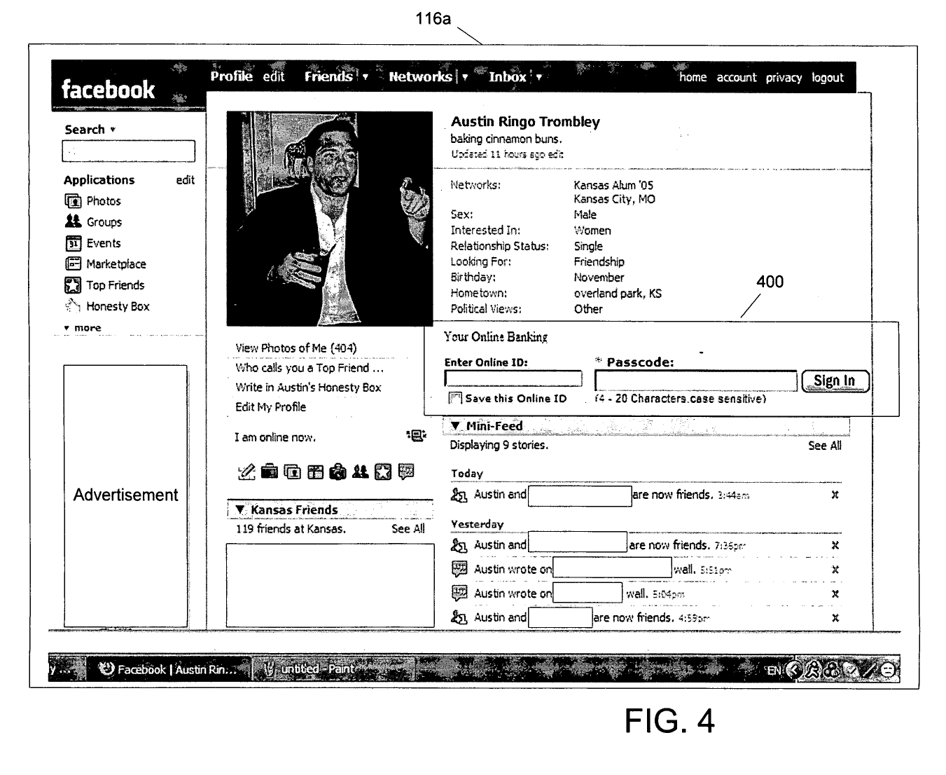

FIG. 4 shows an example of a banking dashboard 400 presented within the user console 116a. Users 112 of the social networking platform 112 can access and monitor their bank accounts through a dashboard screen and obtain other financial services. The banking dashboard 400 includes dialog boxes into which a user 112a must enter his or her online identification and passcode to access his or her accounts from the banking platform 130.

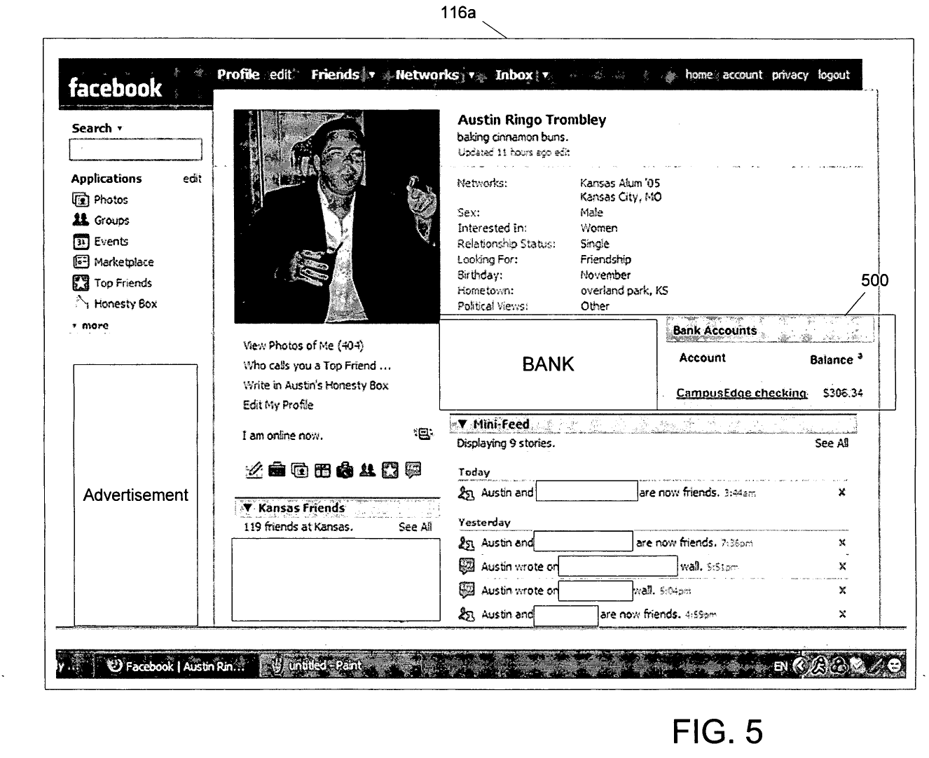

FIG. 5 shows an example of a banking dashboard 500 that displays account information, including accounts and balances, after a user 112a has logged into his or her account using their online banking ID and online banking password. The account information may be displayed through a portal that connects the social networking platform 120 to the banking platform 130.

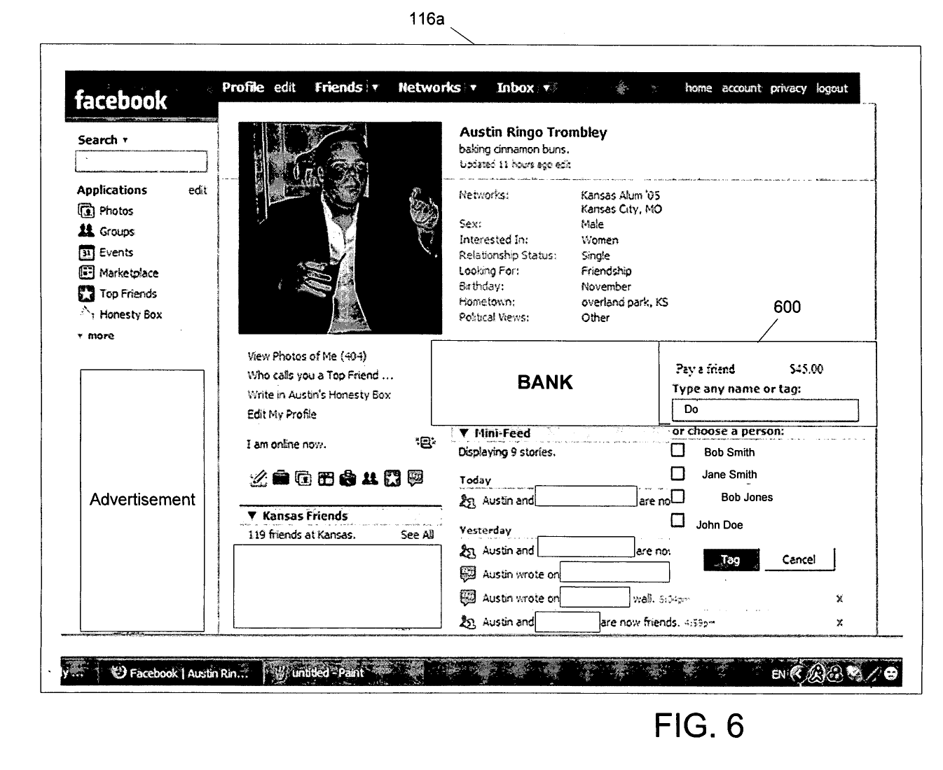

FIG. 6 shows an example of a banking dashboard 600 in which a user enters a request to transfer funds to other members of the social networking service. The banking dashboard 600 includes a dialog box in which the user 112a can specify the amount of funds to be transferred and the recipient of the funds. When selecting a recipient, the user 112a may enter the name of the recipient directly into the dialog box or the user 112a can select a name from a pull down menu that includes the names of users with which the user 112a has an established relationship, e.g., those users who are recognized as “friends” of the user 112a.

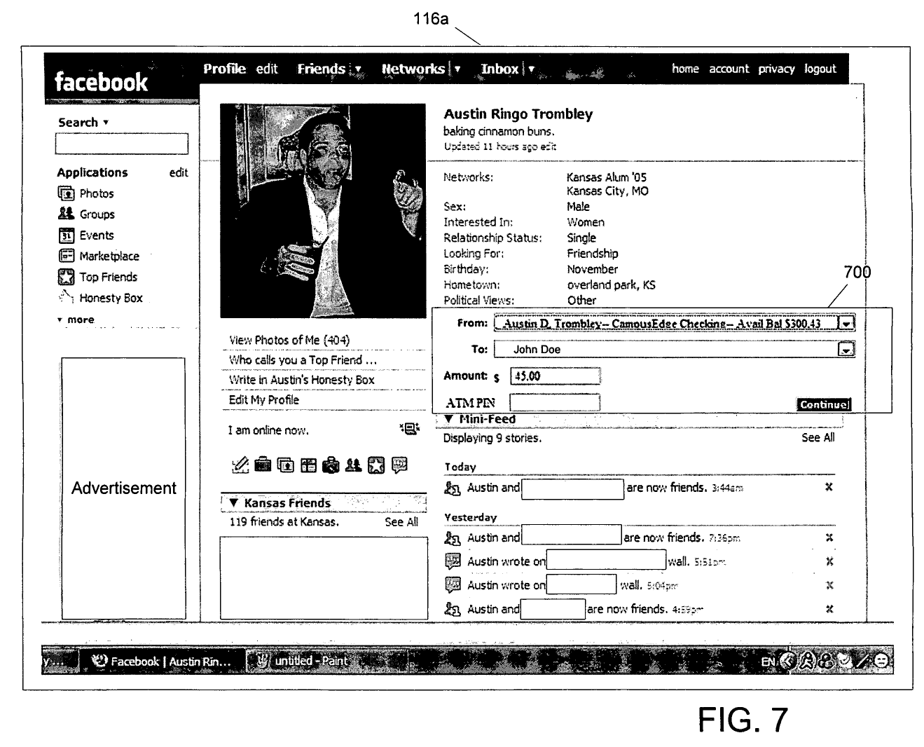

FIG. 7 shows an example of a banking dashboard 700 that verifies the account from which the funds will be transferred, the amount of the funds, and the recipient. The dashboard 700 also prompts the user 112a for an ATM PIN to his checking account to complete the transfer of funds.

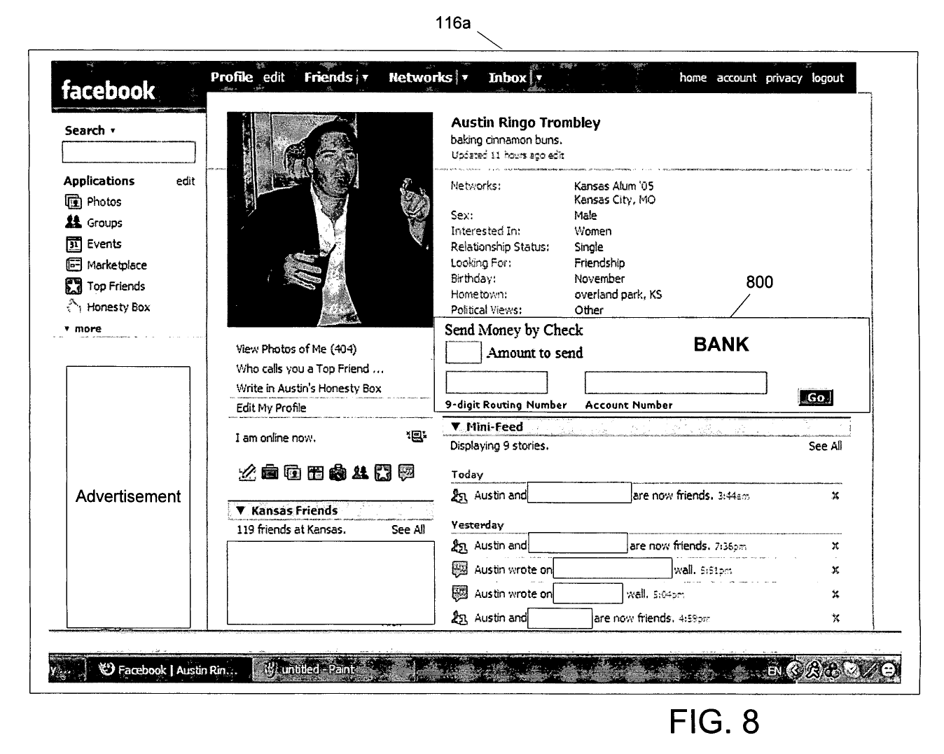

FIG. 8 shows an example of a banking dashboard 800 that enables a user 112a of the social networking service to send money to another member of the service or to a nonmember through an online check.

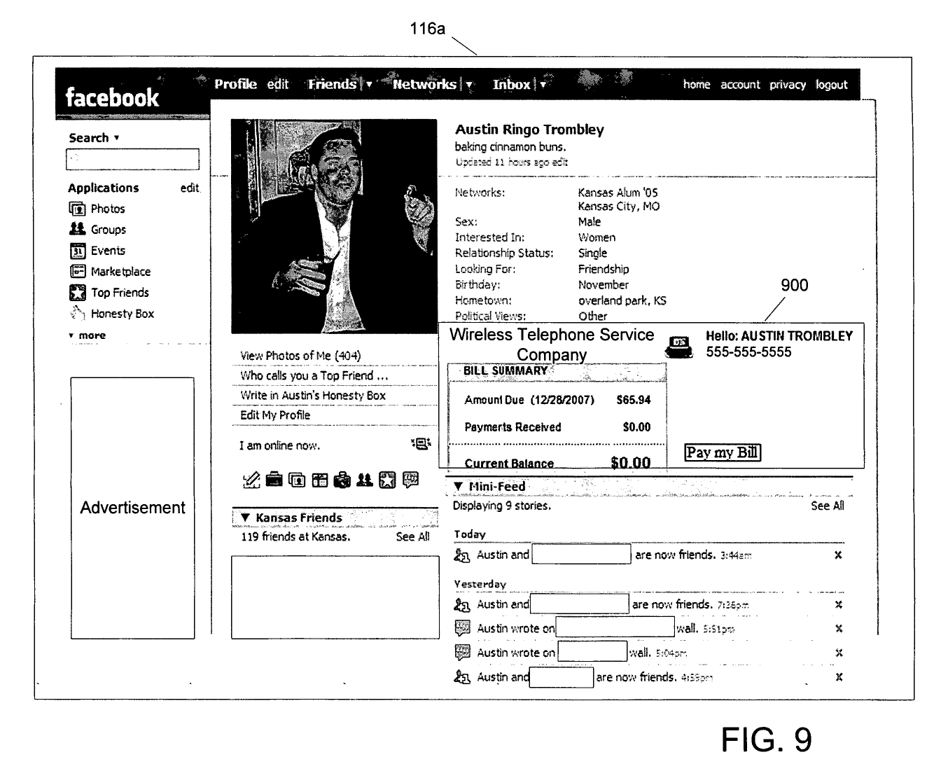

FIG. 9 shows an example of a banking dashboard 900 that enables a user 112a of the social networking service to pay a bill that another member or third party company has sent to him or her via the social networking platform 120. In this example, the banking dashboard 900 enables the user 112a to access an account on the third party platform 160 and pay a bill using funds from the selected account.

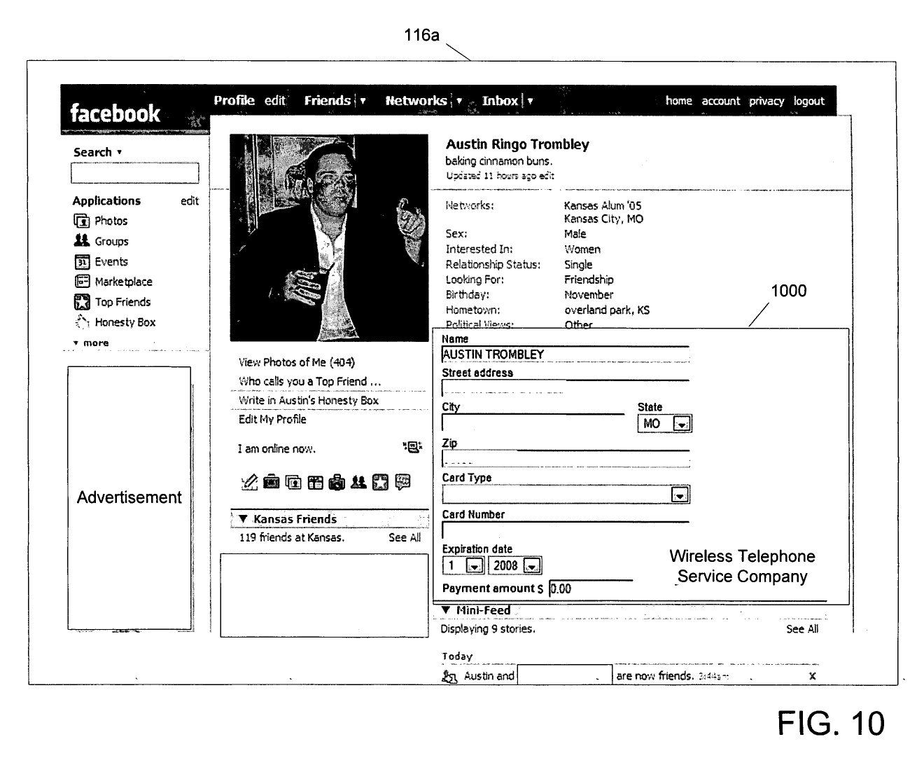

FIG. 10 shows an example of a banking dashboard 1000 that enables a user 112a of the social networking service to pay a bill that another member or company has sent to him or her through the social networking platform 120 with a credit card. The dashboard 1000 also enables the user to pay other members and nonmember third parties with a credit card. The dashboard 1000 includes dialog boxes in which the user 112a enters his or her name, billing address, credit card information, and payment amount. The entered information is sent to the clearing house server 140, which processes the information to debit the user's 112a credit card account by the specified payment amount and transfer the funds to the recipient's account.

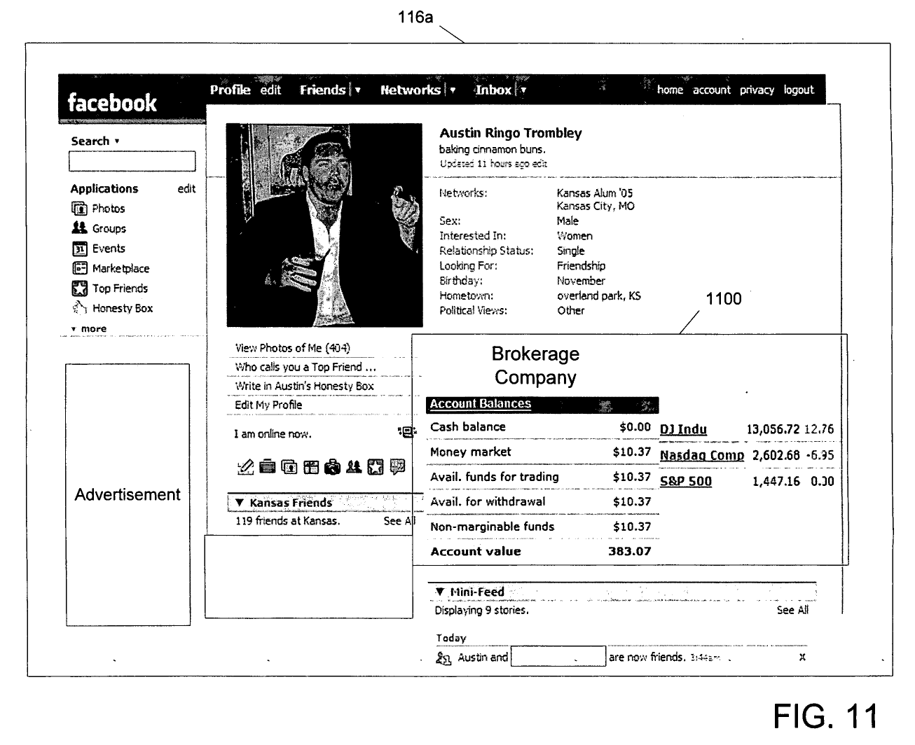

FIG. 11 shows an example of a banking dashboard 1100 that enables a user 112a of the social networking service to access their brokerage account. Using the dashboard, the user 112a may withdraw and transfer funds, e.g., to other users or third parties, transfer funds from other accounts, e.g., banking accounts, into the brokerage account, and perform other financial activities involving the brokerage account.

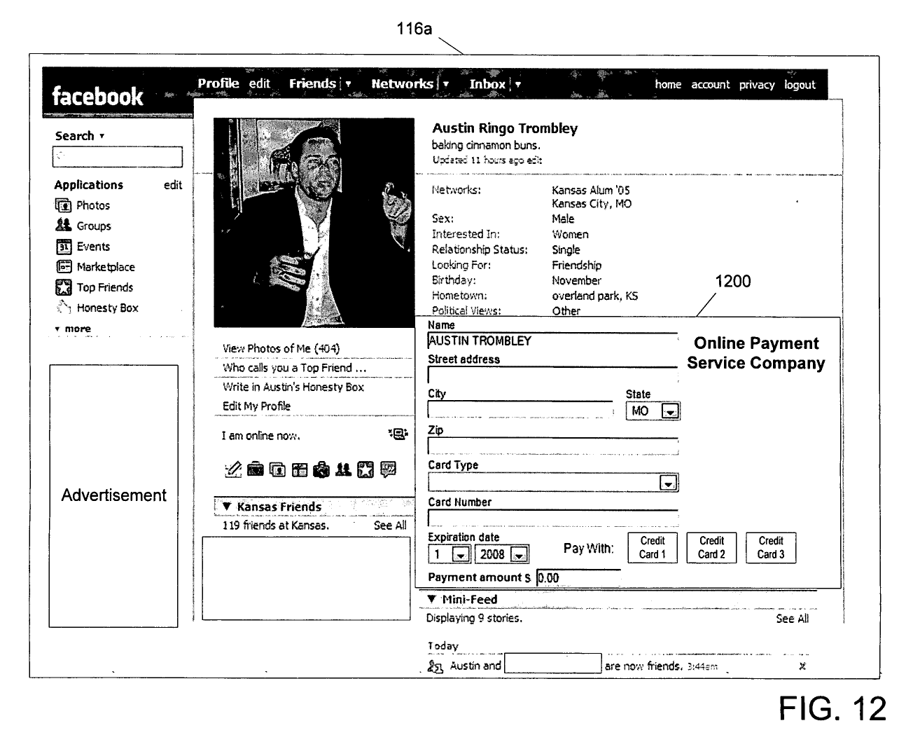

FIG. 12 shows an example of a banking dashboard 1200 that enables a user 112a of the social networking service to access an e-commerce account from an online payment service platform, e.g., a PayPal™ account, and fund transactions from the account. For example, the user 112a is able to pay a roommate his or her share of the utility bills through the social networking platform's integration with the online payment service platform.

The system shown in FIG. 1 could be implemented in the context of a variety of business models in which revenue is derived from various parties. One or more of the social networking platform 120, the clearing house platform 140, the banking platform 130, and the third party platform may collect a fee when a transaction is completed. The fee may be exacted as a flat fee per transaction or may be charged as a percentage (e.g., 1%) of the amount transferred per transaction. The fee may also be adjusted according to the amount of the funds transferred. The revenue could be reserved entirely for the operator of the social networking platform 120 or could be shared with other parties participating in the transaction. For example, the social networking platform 120 may split the fee with the banking platform 130 and the clearing house platform 140 according to an agreement, e.g., with a first percentage of the fee going to the social networking platform 120, a second percentage going to the clearing house platform 140 and the remaining percentage going to the banking platform 130. The distribution of revenue may be adjusted depending on the amount of funds transferred.

In some embodiments, one or more of the social networking platform 120 or the clearing house platform 140 hold funds collected from users bank accounts in a purse account. Funds from the purse account are applied to transactions rather than funds from the users' bank accounts. Users can transfer funds from their bank accounts to the purse account at anytime using the tools provided by the social networking platform 120. The social networking platform 120 or clearing house platform 140 may derive further revenue from interest collected on funds held in the purse account.

Financial arrangements that implement the business models may be governed by routine and automated processes, for example, the transfer of funds after approval and verification has been obtained. The social networking platform 120 provides a medium for exchange of the revenue and payments contemplated by each business model through a financial management processor 125. Although the financial management processor 125 is shown to be located within the social networking platform 120, it could exist as a separate entity or could be combined with one or more of the clearing house platform 140, the banking platform 130, and the third party platform 160.

A number of embodiments of the invention have been described. Nevertheless, it will be understood that various modifications may be made without departing from the spirit and scope of the invention. The foregoing are examples for illustration only and not to limit the alternatives in any way.

The computer processes described herein, including process 200, can be implemented in digital electronic circuitry, or in computer software, firmware, or hardware, including the structural means disclosed in this specification and structural equivalents thereof, or in combinations of them. The processes can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes described herein, including method steps, can be performed by one or more programmable processors executing one or more computer programs to perform functions of the processes by operating on input data and generating output. The processes can also be performed by, and apparatus of the processes can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer-readable media suitable for embodying computer program instructions and data include all forms of nonvolatile memory, including by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The processes can be implemented in a computing system that includes a back end component (e.g., a data server), a middleware component (e.g., an application server), or a front end component (e.g., a client computer having a graphical user interface or a Web browser through which a user can interact with an implementation of the processes), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The steps of the process 200 may be performed in orderings other than those shown in corresponding FIGS. 2A-B. For examples, some of the steps of the process 200 may be eliminated, repeated, or combined with additional steps. Elements of different embodiments described herein may be combined to form other embodiments not specifically set forth above. Accordingly, other embodiments are within the scope of the following claims.

What is claimed is:

1. A method comprising:
integrating an online social networking platform with a banking platform to enable users of the online social networking platform to transfer funds held in one or more accounts accessed through the banking platform to a third party.

2. The method of claim 1, wherein the third party comprises one or more other users of the social networking platform.

3. The method of claim 1, wherein the third party comprises one of: a company, corporation, and organization.

4. The method of claim 1, wherein the one or more accounts comprise one or more of: a checking account, a savings account, a brokerage account, and a credit card account.

5. A method comprising:
providing a user of an online social networking platform with access to a first account associated with a monetary instrument, the first account belonging to the user; and
enabling the user to transfer a selected amount of funds from the first account to a second account, wherein the second account belongs to a third party.

6. The method of claim 5, further comprising:
requesting authentication information from the user; and
verifying the authentication information before providing the user access to the first account.

7. The method of claim 5, further comprising:
requesting authentication information from the user before initiating a transfer of the funds.

8. The method of claim 7, wherein the authentication information is a personal identification number associated with the first account.

9. A method comprising:
retrieving account information from a banking platform, the account information associated with an account belonging to a user;
providing the account information to an online social networking platform configured to display the account information to the user;
receiving a user command to transfer funds from the account to a designated recipient; and
transferring the funds from the account belonging to the user to an account belonging to the designated recipient.

10. The method of claim 9, further comprising:
requesting authentication information from the user; and
providing the authentication information to the banking platform to verify the identity of the user.

11. The method of claim 9, wherein the designated recipient is another user of the online social networking platform, the user and the designated recipient previously establishing a relationship through the social networking platform.

12. The method of claim 9, further comprising:
providing confirmation of a processed transaction to the user from the social networking platform, the confirmation displaying the amount of transferred funds and the recipient of the funds.

13. A method performed at an online social networking platform, the method comprising:
enabling a user to transfer funds from a first account belonging to the user to a second account belonging to a third party; and
deriving revenue from a transfer of the funds and distributing at least portions of the revenue to a party that operates the social networking platform.

14. The method of claim 13, wherein deriving revenue comprises collecting a percentage of the amount of funds transferred.

15. The method of claim 13, wherein deriving revenue comprises collecting a fixed fee in exchange for initiating the transfer of funds.

16. The method of claim 13, further comprising:
adjusting the derivation and distribution of revenue according to the amount of the funds transferred.

17. A method comprising:
compensating a provider of a third party platform for providing financial services to a user through a social networking platform, the third party platform being in electronic communication with the social networking platform and a banking platform, the banking platform providing access to one or more accounts belonging to the user.

18. The method of claim 17, further comprising:
storing information corresponding to the one or more accounts at the third party platform, the third party platform handling transactions with the banking platform.

19. The method of claim 17, wherein compensating further comprises collecting fees charged to the user for depositing funds to and withdrawing funds from the one or more accounts.

20. The method of claim 17, further comprising:
holding funds collected from the one or more accounts in a purse account maintained by the third party platform;
using the funds held in the purse account to provide the financial services; and
wherein compensating further comprises collecting interest on funds held in the purse account.

21. The method of claim 17, wherein providing financial services comprises one or more of: transferring funds from the one or more accounts to a third party; and depositing funds received from another user of the social networking platform to the one or more accounts.

22. The method of claim 21, wherein the one or more accounts comprise one or more of: a savings account, a checking account, a brokerage account, and a credit card account.

23. A system comprising:
a social networking platform configured to provide social networking services and financial services to a plurality of users interacting with the social networking platform using client computers communicatively coupled to the social networking platform.

24. The system of claim 23, further comprising:
a banking platform coupled to the social networking platform, the banking platform including an accounts database storing account information of accounts belonging to one or more of the plurality of users.

25. The system of claim 23, further comprising:
a clearing house platform coupled to the social networking platform and the banking platform, the clearing house platform configured to realize financial transactions initiated between the social networking platform and the banking platform.
